(19) United States
(12) Patent Application Publication
(10) Pub. No.: US 2010/0222452 A1
(43) Pub. Date: Sep. 2, 2010

(54) ANTIFOULING COATING

(75) Inventor: Daisaku Kawahara, Tokyo (JP)

Correspondence Address: KNOBBE MARTENS OLSON & BEAR LLP, 2040 MAIN STREET, FOURTEENTH FLOOR, IRVINE, CA, 92614, US

(73) Assignee: TAIMEITECH CO., LTD., Chiyoda-ku, Tokyo (JP)

(21) Appl. No.: 12/680,890

(22) PCT Filed: Aug. 27, 2008
(86) PCT No.: PCT/JP2008/065790

§ 371 Date: Mar. 30, 2010

(30) Foreign Application Priority Data
Oct. 9, 2007 (JP) 2007-263511

(51) Int. Cl. C09D 5/16

(52) U.S. Cl. 523/122

(57) ABSTRACT

Provided is a technique for preventing the adhesion of marine organisms to marine vessels, undersea structures, fishing gears, etc. over a long period of time, in particular, an environmentally-safe antifouling coating which makes it possible to prevent the adhesion of large-sized marine organisms. An antifouling coating including an antimicrobial composition each containing a nitrile-based antimicrobial agent, a pyridine-based antimicrobial agent, a haloalkylthio-based antimicrobial agent, an organic iodo-based antimicrobial agent, a thiazole-based antimicrobial agent, and a benzimidazole-based antimicrobial agent; an inorganic copper compound; a silicone-acrylic resin in which a content of silicone is 3 to 15 mass %; and a silicone oil is applied to marine vessels, undersea structures, fishing gears, etc.

### TECHNICAL FIELD

The present invention relates to an antifouling coating for preventing the adhesion of marine organisms such as shellfish and seaweed to articles, which are used under the sea over a long period of time, such as marine vessels, undersea structures, and fishing gears.

### BACKGROUND ART

Since marine vessels, undersea structures, fishing gears, etc. are used under the sea over a long period of time, marine organisms such as seaweed, barnacle, serpula, bryozoan, and mollusks adhere thereto. Thus, the maintenance thereof requires a great deal of labor and high cost.

In order to prevent the corrosion of undersea structures and the reduction in the navigation speed of marine vessels due to such marine organisms and also to prevent death of fishery product due to the adhesion of the marine organisms to fishing gears such as a net and a wire netting for culturing fish, an antifouling coating containing an organic tin compound has been conventionally used.

However, the organic tin compound posed a problem with environmental toxicity, particularly accumulation of toxic substances in fish, and thus the use thereof has been limited. Under the above-described circumstances, the utilization of inorganic copper compounds such as cuprous oxide has drawn attention as antifouling components.

For example, an antifouling coating in which a beryllium-copper alloy powder is dispersed has been developed (Patent Document 1). Moreover, an antifouling coating has been developed, in which antifoulants such as an inorganic copper compound (e.g., cuprous oxide) and 1,3-dicyano-2,4,5,6-tetrachlorobenzene are dispersed in resin having a reactive functional group such as a carboxy group to emit the antifoulant over a long period of time (Patent Document 2). Moreover, waterborne antifouling compositions containing copper and/or a copper compound and polyether silicone also have been developed (Patent Document 3).

On the other hand, an antifoulant containing no heavy metal also has been developed. For example, an antifoulant for fishnets in which triphenyl boron pyridine and a silicone oil are contained in resin (Patent Document 4); an antifoulant for fishnets containing polyether silicone, a triphenyl boron.rosin amine complex or a triphenyl boron.alkylamine complex, resin, and a solvent (Patent Document 5); an antifouling coating composition containing bisdimethyl dithiocarbamoyl zinc ethylene bisdithiocarbamate, (meth)acrylate resin, polyether silicone, and monobasic acid (Patent Document 6); etc. haven been developed.

Moreover, a technique has been developed, the technique using a block copolymer containing a polysiloxane block, acrylic resin block, and specific metal-containing bond as a component for an antifouling coating (Patent Document 7 and Patent Document 8).

However, with the conventional techniques, it was difficult to prevent the adhesion of large-sized marine organisms over a long period of time. Thus, the development of an antifouling coating with higher antifouling property has been desired.

Meanwhile, known is an antimicrobial composition each containing a nitrile-based antimicrobial agent, pyridine-based antimicrobial agent, haloalkylthio-based antimicrobial agent, organic iodo-based antimicrobial agent, thiazole-based antimicrobial agent, and benzimidazole-based antimicrobial agent as an active ingredient (Patent Document 9). It is also known that such an antimicrobial composition prevents the growth of various bacteria, fungi, and microalgae.

[Patent Document 1] JP 6-228468 A

[Patent Document 2] JP 7-166107 A

[Patent Document 3] JP 2006-193731 A

[Patent Document 4] JP 7-133207 A

[Patent Document 5] JP 11-199414 A

[Patent Document 6] JP 2002-80778 A

[Patent Document 7] JP 2001-72869 A

[Patent Document 8] JP 2006-77095 A

[Patent Document 9] JP 3526919 B

### DISCLOSURE OF INVENTION

The present invention aims to provide a technique for preventing the adhesion of marine organisms to marine vessels, undersea structures, fishing gears, etc. over a long period of time. In particular, the present invention aims to provide an environmentally-safe antifouling coating which makes it possible to prevent the adhesion of large-sized marine organisms.

In order to solve the above-described problems, the inventors of the present invention have conducted extensive researches on the mechanism of the adhesion of large-sized marine organisms and components effective for preventing the adhesion thereof. In order to prevent the adhesion of large-sized marine organisms, the inventors of the present invention have examined the inhibition of the growth of bacteria and the inducement of adhesion rejection. As a result, the inventors of the present invention found that fishnets and ship bottoms which have been coated with an antifouling coating containing an antimicrobial composition containing a nitrile-based antimicrobial agent, pyridine-based antimicrobial agent, haloalkylthio-based antimicrobial agent, organic iodo-based antimicrobial agent, thiazole-based antimicrobial agent, and benzimidazole-based antimicrobial agent; an inorganic copper compound; and a silicone-acrylic resin containing silicone in a proportion of 3 to 15 mass % do not suffer from the adhesion of various marine organisms including large-sized marine organisms over a long period of time. Based on these findings, the present invention has been accomplished.

More specifically, the present invention is as follows.

(1) An antifouling coating including an antimicrobial composition, copper and/or an inorganic copper compound, a silicone-acrylic resin, and a silicone oil, in which the antimicrobial composition contains a nitrile-based antimicrobial agent, a pyridine-based antimicrobial agent, a haloalkylthio-based antimicrobial agent, an organic iodo-based antimicrobial agent, a thiazole-based antimicrobial agent, and a benzimidazole-based antimicrobial agent, and a content of silicone in the silicone-acrylic resin is 3 to 15 mass %.

(2) The antifouling coating according to the item (1), in which the antimicrobial composition contains a haloisophthalonitrile compound, a sulfonyl halopyridine compound and/or a pyridinethiol-1-oxide compound, a haloalkyl thiosulfimide compound, an iodosulfonyl benzene compound, an isothiazoline-3-one compound, and a benzimidazole carbamic acid compound and/or a cyclic compound derivative of benzimidazole.

(3) The antifouling coating according to the item 1 or 2, in which a content of the antimicrobial composition is 3 to 15 mass %.

(4) The antifouling coating according to the item 2 or 3, in which the antimicrobial composition contains 2,4,5,6-tetrachloroisophthalonitrile, 2,3,5,6-tetrachloro-4-methylsulfonyl pyridine, sodium 2-pyridinethiol-1-oxide, N,N-dimethyl-N′-phenyl-N′-(fluorodichloromethylthio)sulfimide, diiodomethyl-p-tolyl sulfone, 2-(n-octyl)-4-isothiazoline-3-one, 1H-2-benzimidazole methyl carbamate, and 2-(4-thiazolyl)-1H-benzimidazole.

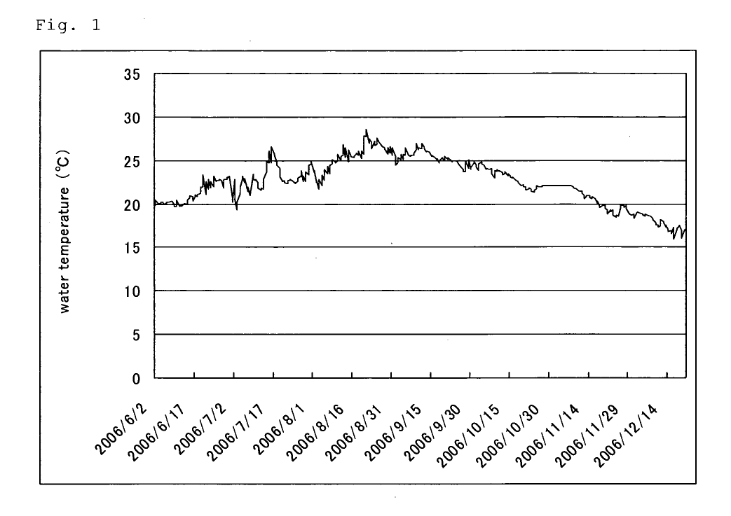

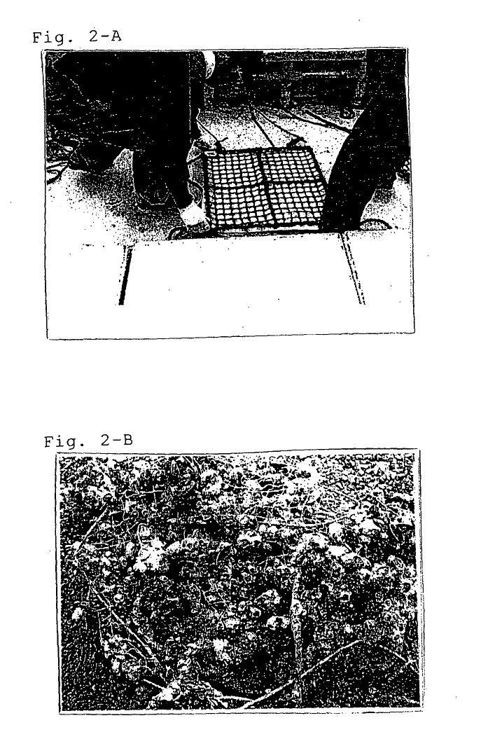

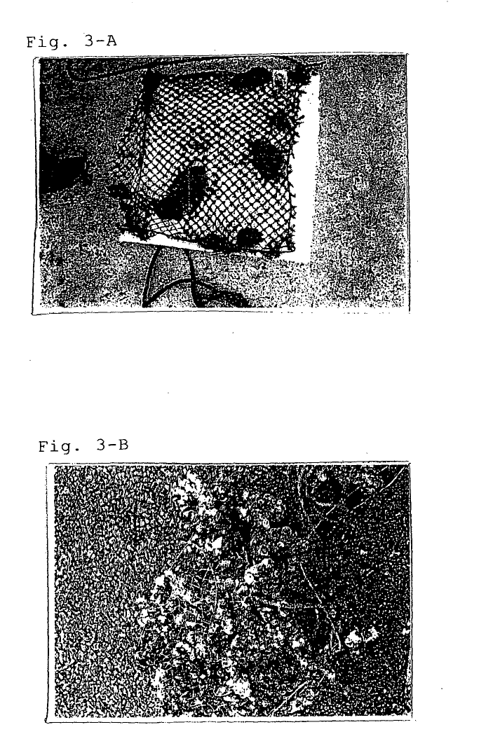

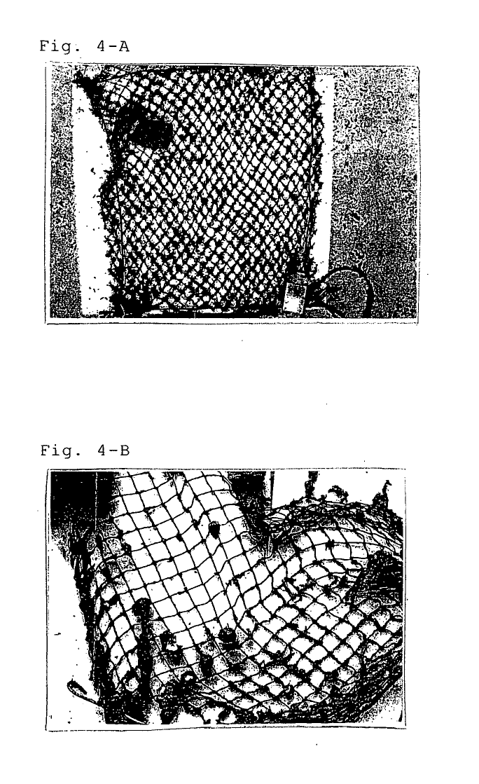

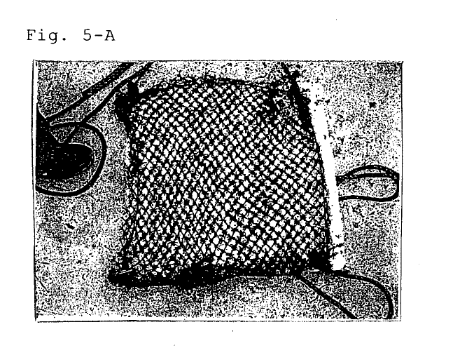

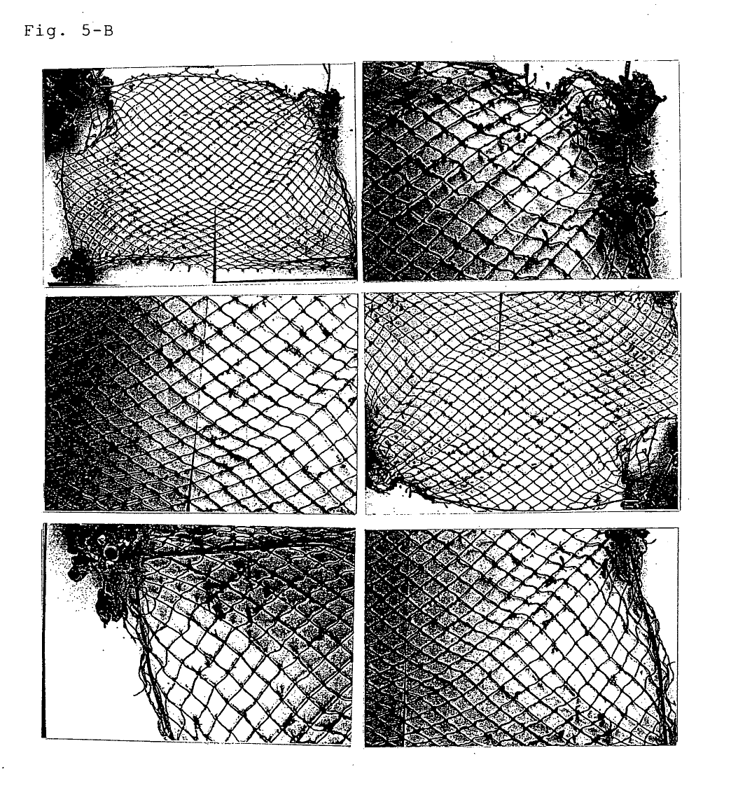

### BRIEF DESCRIPTION OF DRAWINGS

[FIG. 1] A graph illustrating the changes in coastal sea temperature during an experiment period.

[FIG. 2-A] A photograph of a test piece of Comparative Example 1 on the 35th day.

[FIG. 2-B] A photograph of a test piece of Comparative Example 1 on the 202nd day.

[FIG. 3-A] A photograph of a test piece of Example 1 on the 35th day.

[FIG. 3-B] A photograph of a test piece of Example 1 on the 202nd day.

[FIG. 4-A] A photograph of a test piece of Example 2 on the 35th day.

[FIG. 4-B] A photograph of a test piece of Example 2 on the 202nd day.

[FIG. 5-A] A photograph of a test piece of Example 3 on the 35th day.

[FIG. 5-B] Photographs of a test piece of Example 3 on the 202nd day.

### BEST MODE FOR CARRYING OUT THE INVENTION

The antifouling coating of the present invention contains an antimicrobial composition, copper and/or an inorganic copper compound, a silicone-acrylic resin, and a silicone oil.

### (1) Antimicrobial Composition

In the antifouling coating of the present invention, the antimicrobial composition contains a nitrile-based antimicrobial agent, pyridine-based antimicrobial agent, haloalkylthio-based antimicrobial agent, organic iodo-based antimicrobial agent, thiazole-based antimicrobial agent, and benzimidazole-based antimicrobial agent.

It should be noted that the “antimicrobial” as used in the present invention refers to inhibiting the growth of bacteria, prokaryotic algae, eumycetes such as molds, yeasts, and fungi, and eucaryotic algae.

As the nitrile-based antimicrobial agent, haloarylnitrile compounds are preferred and haloisophthalonitrile compounds are more preferred. Examples of the haloisophthalonitrile compounds include 2,4,5,6-tetrachloroisophthalonitrile and 5-chloro-2,4,6-trifluoroisophthalonitrile.

As the pyridine-based antimicrobial agent, halogenated pyridine derivatives, pyridinethiol-1-oxide compounds, and the like are preferred, and sulfonylhalopyridine compounds, pyridinethiol-1-oxide compounds, and the like are more preferred.

Examples of the halogenated pyridine derivatives include 2-chloro-6-trichloromethyl pyridine, 2-chloro-4-trichloromethyl-6-methoxy pyridine, 2-chloro-4-trichloromethyl-6-(2-furylmethoxy)pyridine, di(4-chlorophenyl)pyridylmethanol, and 2,3,5,6-tetrachloro-4-methylsulfonyl pyridine and 2,3,5-trichloro-4-(n-propylsulfonyl)pyridine which are classified into sulfonyl halopyridine compounds. Examples of the pyridinethiol-1-oxide compounds include sodium 2-pyridinethiol-1-oxide, zinc 2-pyridinethiol-1-oxide, and di(2-pyridinethiol-1-oxide).

As the haloalkylthio-based antimicrobial agent, haloalkylthiophthalimide compounds, haloalkylthiotetrahydrophthalimide compounds, haloalkylthiosulfamide compounds, and haloalkylthiosulfimide compounds, and the like are preferred, and haloalkylthiosulfimide compounds are more preferred.

Examples of the haloalkylthiophthalimide compounds include N-fluorodichloromethylthiophthalimide and N-trichloromethylthiophthalimide. Examples of the haloalkylthiotetrahydrophthalimide compounds include N-1,1,2,2-tetrachloroethylthiotetrahydrophthalimide and N-trichloromethylthiotetrahydrophthalimide.

In addition, examples of the haloalkylthiosufamide compounds include N-trichloromethylthio-N-(phenyl)methylsulfamide, N-trichloromethylthio-N-(4-chlorophenyl)methylsulfamide, N-(1-fluoro-1,1,2,2-tetrachloroethylthio)-N-(phenyl)methylsulfamide, and N-(1,1-difluoro-1,2,2-trichloroethylthio)-N-(phenyl)methylsulfamide. Examples of the haloalkylthiosulfimide compounds include N,N-dimethyl-N′-phenyl-N′-(fluorodichloromethylthio)sulfimide, N,N-dichlorofluoromethylthio-N′-phenylsulfimide, and N,N-dimethyl-N′-(p-tolyl)-N′-(fluorodichloromethylthio)sulfimide.

As the organic iodo-based antimicrobial agent, iodosulfone compounds and unsaturated aliphatic iodide compounds are preferred, and iodosulfonylbenzene compounds are more preferred.

Examples of the iodosulfonyl compounds include diiodomethyl-p-tolylsulfone, 1-diiodomethylsulfonyl-4-methylbenzene, and 1-diiodomethylsulfonyl-4-chlorobenzene, which are iodosulfonyl benzene compounds. In addition, examples of the unsaturated aliphatic iodide compounds include 3-iodo-2-propargylbutyl carbamic acid, 4-chlorophenyl-3-iodopropargyl formal, 3-ethoxycarbonyloxy-1-bromo-1,2-diiodo-1-propene, and 2,3,3-triiodoallyl alcohol.

As the thiazole-based antimicrobial agent, isothiazoline-3-one compounds and benzthiazole compounds are preferred, and isothiazoline-3-one compounds are more preferred.

Examples of the isothiazoline-3-one compounds include 1,2-benzisothiazoline-3-one, 2-(n-octyl)-4-isothiazoline-3-one, 5-chloro-2-methyl-4-isothiazoline-3-one, 2-methyl-4-isothiazoline-3-one, and 4,5-dichloro-2-cyclohexyl-4-isothiazoline-3-one. Examples of the benzthiazole compounds include 2-(4-thiocyanomethylthio)benzthiazole, sodium 2-mercaptobenzthiazole, and zinc 2-mercaptobenzthiazole.

As the benzimidazole-based antimicrobial agent, benzimidazole carbamic acid compounds, sulfur atom-containing benzimidazole compounds, and ring compound derivatives of benzimidazole are preferred, and benzimidazole carbamic acid compounds and ring compound derivatives of benzimidazole are more preferred.

Examples of the benzimidazole carbamic acid compounds include 1H-2-benzimidazole methyl carbamate, 1-butylcarbamoyl-2-benzimidazole methyl carbamate, 6-benzoyl-1H-2-benzimidazol methyl carbamate, and 6-(2-thiophenecarbonyl)-1H-2-benzimidazole methyl carbamate.

In addition, examples of the sulfur atom-containing benzimidazole compounds include 1H-2-thiocyanomethylthiobenzimidazole, and 1-dimethylaminosulfonyl-2-cyano-4-bromo-6-trifluoromethyl benzimidazole.

Examples of the ring compound derivatives of benzimidazole include 2-(4-thiazolyl)-1H-benzimidazole, 2-(2-chlorophenyl)-1H-benzimidazole, 2-(1-(3,5-dimethylpyrazolyl)-1H-benzimidazole, and 2-(2-furyl)-1H-benzimidazole.

The antimicrobial composition for use in the antifouling coating of the present invention can be produced by selecting at least one compound from each of the six antimicrobial agent groups of the above-mentioned nitrile-based antimicrobial agents, pyridine-based antimicrobial agents, haloalkylthio-based antimicrobial agents, organic iodo-based antimicrobial agents, thiazole-based antimicrobial agents, and benzimidazole-based antimicrobial agents.

The content of each antimicrobial agent group in the antimicrobial composition is not limited. In general, the contents of the nitrile-based antimicrobial agent and the pyridine-based antimicrobial agent are 10 to 30 mass %, and preferably 15 to 25 mass %; the content of the haloalkylthio-based antimicrobial agent is 2 to 20 mass %, and preferably 5 to 15 mass %; the content of the organic iodo-based antimicrobial agent is 15 to 35 mass %, and preferably 22 to 32 mass %; the content of the thiazole-based antimicrobial agent is 5 to 25 mass %, and preferably 10 to 20 mass %; and the content of the benzimidazole-based antimicrobial agent is 2 to 20 mass %, and preferably 5 to 15 mass %.

All the above-mentioned compounds are well known, and can be easily produced by a usual production method. Moreover, commercially available substances can also be used.

The content of the antimicrobial composition in the antifouling coating of the present invention is preferably 3 to 15 mass %, more preferably 4 to 10 mass %, and still more preferably 5 to 9 mass %.

(2) Copper and/or Inorganic Copper Compound

Mentioned as an inorganic copper compound are cuprous oxide, thiocyanate copper (copper rhodanide), basic copper sulfate, basic copper acetate, basic copper carbonate, cupric hydroxide, etc.

For the antifouling coating of the present invention, copper, cuprous oxide, copper rhodanide, etc. are preferably used.

The content of copper and/or an inorganic copper compound in the antifouling coating of the present invention is preferably 0.1 to 10 mass %, more preferably 0.2 to 7 mass %, and still more preferably 0.5 to 3.5 mass %.

The copper and/or the inorganic copper compound can be blended by a usual method, and is preferably blended, for example, in the form of a powder.

### (3) Silicone-Acrylic Resin

In the present invention, the “silicone-acrylic resin” refers to resin containing siloxane having an organic group (organosiloxane) and (meth)acrylic acid and/or (meth)acrylate as a constituent unit.

Examples of the organosiloxane include dimethylsiloxane or a compound in which a methyl group of organosiloxane is substituted with an alkyl group, an aralkyl group, an epoxy group, a carboxyl group, an amino group, an acyl group, an imino group, fluorine, hydrogen, or the like. Of those, dimethylsiloxane is preferred.

Examples of (meth)acrylate include methyl (meth)acrylate, ethyl (meth)acrylate, butyl (meth)acrylate, 2-ethylhexyl (meth)acrylate, and methoxyethyl (meth)acrylate.

The content of the organosiloxane in the silicone-acrylic resin is 3 to 15 mass %, preferably 5 to 13 mass %, and more preferably 7 to 11 mass %. Moreover, the content of the (meth)acrylic acid and/or the (meth)acrylate in the silicone-acrylic resin is preferably 80 to 97 mass %, more preferably 82 to 95 mass %, and still more preferably 84 to 93 mass %.

The silicone-acrylic resin may contain a monomer constituent unit other than the organosiloxane and (meth)acrylic acid and/or (meth)acrylate. The content thereof is preferably 5 mass % or less, more preferably 3 mass % or less, and still more preferably 2 mass % or less. The silicone-acrylic resin is preferably a random copolymer of the organosiloxane and (meth)acrylic acid and/or (meth)acrylate.

The viscosity of the silicone-acrylic resin may be in the range at which the silicone-acrylic resin can be usually used as a resin component of a coating. For example, the viscosity at 20° C. is preferably 1 to 1,000 mm²/s, and more preferably 10 to 5,000 mm²/s. Moreover, the number average molecular weight of the silicone-acrylic resin may be suitably determined in such a manner as to achieve such a viscosity. For example, the number average molecular weight is 50 to 50,000, and preferably 500 to 10,000.

The silicone-acrylic resin can be produced by polymerization by a conventional method using, as a raw material, a monomer constituent unit in the above-mentioned mass range.

The content of the above-mentioned silicone-acrylic resin in the antifouling coating of the present invention is preferably 50 to 90 mass %, and more preferably 70 to 85 mass %.

### (4) Silicone Oil

Mentioned as the silicone oil in the antifouling coating of the present invention is dimethylpolysiloxane or modified dimethylpolysiloxane in which a part of the methyl groups of dimethylpolysiloxane is substituted by another substituent such as a phenyl group, alkyl group, aralkyl group, epoxy group, carboxy group, amino group, acyl group, imino group, fluorine, or hydrogen. Of those, dimethylpolysiloxane is preferable. The viscosity of the silicone oil maybe in the range at which the silicone oil is generally used as a component of a coating.

As the silicone oil, commercially available substances can be used.

The content of the silicone oil in the antifouling coating of the present invention is preferably 0.05 to 10 mass %, and more preferably 0.1 to 5 mass %.

### (5) Other Components

Moreover, the antifouling coating of the present invention may further contain resin for ease of coating according to the intended use besides the silicone-acrylic resin. Such resin can be selected from substances that are generally used for a coating, and, for example, polyurethane, polyester, etc. are mentioned. Of those, polyurethane is preferable.

The content of such resin is preferably 0.1 to 20 mass %, more preferably 0.5 to 10 mass %, and still more preferably 0.8 to 4 mass %.

The antifouling coating of the present invention generally contains a solvent in order to improve usability. There is no limitation on the solvent insofar as the solvent is generally used for a coating. For example, aromatic hydrocarbons such as benzene, toluene, xylene, ethylbenzene, and trimethyl benzene; aliphatic hydrocarbons such as hexane and heptane; esters such as ethyl acetate and butyl acetate; ethers such as dioxane and diethyl ether; alcohols such as ethanol, isopropanol, and n-butanol; ketones such as acetone, diethyl ketone, and methyl isobutyl ketone; etc. are mentioned.

The amount of the solvent in the antifouling coating of the present invention can be determined according to the viscosity of a coating, a coating method, a coating target, etc. The amount of the solvent is preferably 1 to 30 mass %, and more preferably 2 to 20 mass %.

The antifouling coating of the present invention may further contain an additive which is generally used for an antifouling coating.

Mentioned as such an additive are a color pigment, antisagging agent, plasticizer, dispersant, defoaming agent, surfactant, etc.

### (6) Antifouling Coating of the Present Invention

The antifouling coating of the present invention can be produced by mixing the above-mentioned components by a conventional method.

The antifouling coating of the present invention is used by applying to articles to which marine organisms adhere. As such articles, marine vessels, undersea structures, and fishing gears are mentioned, for example.

In the case of marine vessels, it is preferable to use the antifouling coating of the present invention particularly for the ship bottom which is below the sea surface over a long period of time.

Moreover, as undersea structures, port facilities, roads along the bay, pipelines, bridges, bases on the sea bottom, undersea tunnels, revetments, intakes, buoys, etc. are mentioned.

Moreover, as fishing gears, nets for culturing fish, set nets, buoys, ropes, etc., are mentioned.

Coating can be performed by a conventional method according to a coating target. For example, when the antifouling coating of the present invention is applied to a fishnet, the application can be carried out by immersing the fishnet in the antifouling coating and drying the resultant.

The antifouling coating of the present invention prevents the adhesion of various marine organisms such as seaweeds, barnacle, sea mussel, serpula, bryozoan, and mollusks.

### Examples

### (1) Production of Antifouling Coating of the Present Invention

2,4,5,6-tetrachloroisophthalonitrile, 2,3,5,6-tetrachloro-4-methylsulfonyl pyridine, sodium 2-pyridinethiol-1-oxide, N,N-dimethyl-N′-phenyl-N′-(fluorodichloromethylthio)sulfimide, diiodomethyl-p-tolylsulfone, 2-(n-octyl)-4-isothiazoline-3-one, 1H-2-benzimidazole methyl carbamate, and 2-(4-thiazolyl)-1H-benzimidazole were blended in the proportion illustrated in Table 1 to produce an antimicrobial composition 1.

TABLE 1

| | Proportion |
|---|---|
| Component | (mass %) |
| 2,4,5,6-tetrachloroisophthalonitrile | 20 |
| 2,3,5,6-tetrachloro-4-methylsulfonyl pyridine | 17 |
| N,N-dimethyl-N′-phenyl-N′- | 9 |
| (fluorodichloromethylthio)sulfimide | |
| 2-(4-thiazolyl)-1H-benzimidazole | 3 |
| Sodium 2-pyridinethiol-1-oxide | 3 |
| diiodomethyl-p-tolylsulfone | 27 |
| 2-(n-octyl)-4-isothiazoline-3-one | 14 |
| 1H-2-benzimidazole methyl carbamate | 7 |

Then, according to the following formulation of Table 2, antifouling coatings (Examples 1 to 3) of the present invention were produced. Moreover, an antifouling coating not containing the above-mentioned antimicrobial compositions (Comparative Example 1) was also produced. A silicone-acrylic resin was obtained by copolymerization using monomers having the following composition ratio by a conventional method (silicone:acrylic=1:9 (mass ratio), viscosity (20° C.): 170±20 mm²/s, and number average molecular weight: 3,800).

As a silicone oil, KF-96-100cs (Shin-Etsu Chemical Co., Ltd., dimethyl silicone oil, kinematic viscosity (25° C.): 100 mm²/s) was used.

Used as a coating containing an inorganic copper powder was “Sankai R” manufactured by BIOTECH TRADE (Composition: 16 mass % of inorganic copper powder, 18 mass % of polyurethane, and 66 mass % of xylene).

Raw materials other than the antimicrobial composition 1 were mixed beforehand, and subsequently, the antimicrobial composition 1 was added to thereby produce an antifouling coating of the present invention.

TABLE 2

| | Content (mass %) | | | |
|---|---|---|---|---|
| | | | | Comparative |
| | Example 1 | Example 2 | Example 3 | Example 1 |
| Antimicrobial | 3 | 5 | 8 | 0 |
| composition 1 | | | | |
| Silicone-acrylic | 81 | 79.5 | 77 | 83 |
| resin | | | | |
| Silicone oil | 2 | 2 | 2 | 2 |
| Sankai R | 14 | 13.5 | 13 | 15 |

### (2) Undersea Experiment

The antifouling coatings of Examples 1 to 3 and Comparative Example 1 produced in (1) above were subjected to an undersea experiment over 6 months.

Experiment Station: Sagami Bay Experiment Station of Kanagawa Prefectural Fisheries Research Institute

Odawara City Fisheries Cooperative Association Set Net Department Ishibashi Fishing Ground

Experiment period: June 2, Heisei 18 (2006) to December 20, Heisei 18 (2006)

Experiment method: Each of the antifouling coatings of Examples 1 to 3 and Comparative Example 1 was applied to a 66 nylon net test piece (60 cm×60 cm), and the resultant was suspended 2 to 3 m below the sea surface using a rope at the set net fishing ground.

Coastal sea temperature: Illustrated in FIG. 1 (The water temperatures at 0:00 and 12:00 of each day were plotted. It should be noted that the measurement was not performed from Oct. 28, 2006 to Nov. 6, 2006.)

The test pieces were pulled up on the 35th day and the 202nd day (final day), and photographs thereof were taken.
Photography: First time July 6, Heisei 18(2006) (on the 35th day)
   Second time December 20, Heisei 18(2006) (on the 202nd day)

The results are illustrated in FIGS. 2 to 5. The photographs of the first photography (on the 35th day) showed that the adhesion of marine organisms was hardly observed on every test piece to which one of the antifouling coatings of Comparative Example 1 and Examples 1 to 3 was applied (FIG. 2-A, FIG. 3-A, FIG. 4-A, and FIG. 5-A).

The photographs of the second photography (on the 202nd day) showed that a lot of marine organisms adhered to the test piece to which the antifouling coating of Comparative Example 1 was applied (FIG. 2-B). Although marine organisms adhered to the test piece to which the antifouling coating of Example 1 was applied, the adhesion amount was smaller as compared with Comparative Example 1 (FIG. 3-B). To the test piece to which the antifouling coating of Example 2 was applied, a small amount of marine organisms adhered (FIG. 4-B). To the test piece to which the antifouling coating of Example 3 was applied, no marine organisms adhered (FIG. 5-B).

It was revealed from the above experimental results that the antifouling coatings of the present invention inhibit the adhesion of marine organisms. Further, it was revealed that there are remarkable differences in the effect of inhibiting the adhesion of marine organisms especially over a long period of time between the case where the content of the antimicrobial composition is 3 mass % and the case where the content of the antimicrobial composition is 5 mass %. Further, it was revealed that when the content of the antimicrobial composition reaches 8 mass %, the adhesion of marine organisms is almost completely inhibited.

### INDUSTRIAL APPLICABILITY

The antifouling coating of the present invention prevents the adhesion of various marine organisms including large-sized marine organisms over a long period of time. Moreover, the antifouling coating of the present invention is also safe for the environment, and thus is excellent in practicability as well.

1. An antifouling coating, comprising:
an antimicrobial composition;
copper and/or an inorganic copper compound;
a silicone-acrylic resin; and
a silicone oil, wherein
the antimicrobial composition contains a nitrile-based antimicrobial agent, a pyridine-based antimicrobial agent, a haloalkylthio-based antimicrobial agent, an organic iodo-based antimicrobial agent, a thiazole-based antimicrobial agent, and a benzimidazole-based antimicrobial agent, and
a content of silicone in the silicone-acrylic resin is 3 to 15 mass %.

2. An antifouling coating according to claim 1, wherein the antimicrobial composition contains a haloisophthalonitrile compound, a sulfonyl halopyridine compound and/or a pyridinethiol-1-oxide compound, a haloalkyl thiosulfimide compound, an iodosulfonyl benzene compound, an isothiazoline-3-one compound, and a benzimidazole carbamic acid compound and/or a cyclic compound derivative of benzimidazole.

3. An antifouling coating according to claim 1, wherein a content of the antimicrobial composition is 3 to 15 mass %.

4. An antifouling coating according to claim 2, wherein the antimicrobial composition contains 2,4,5,6-tetrachloroisophthalonitrile, 2,3,5,6-tetrachloro-4-methylsulfonyl pyridine, sodium 2-pyridinethiol-1-oxide, N,N-dimethyl-N′-phenyl-N′-(fluorodichloromethylthio)sulfimide, diiodomethyl-p-tolyl sulfone, 2-(n-octyl)-4-isothiazoline-3-one, 1H-2-benzimidazole methyl carbamate, and 2-(4-thiazolyl)-1H-benzimidazole.

5. An antifouling coating according to claim 2, wherein a content of the antimicrobial composition is 3 to 15 mass %.

6. An antifouling coating according to claim 3, wherein the antimicrobial composition contains 2,4,5,6-tetrachloroisophthalonitrile, 2,3,5,6-tetrachloro-4-methylsulfonyl pyridine, sodium 2-pyridinethiol-1-oxide, N,N-dimethyl-N′-phenyl-N′-(fluorodichloromethylthio)sulfimide, diiodomethyl-p-tolyl sulfone, 2-(n-octyl)-4-isothiazoline-3-one, 1H-2-benzimidazole methyl carbamate, and 2-(4-thiazolyl)-1H-benzimidazole.
